(19) United States
(12) Patent Application Publication
(10) Pub. No.: US 2014/0261330 A1
(43) Pub. Date: Sep. 18, 2014

(54) INTERNAL SECONDARY FUEL RAIL ORIFICE

(71) Applicant: Robert J. Doherty, Syracuse, IN (US)

(72) Inventor: Robert J. Doherty, Syracuse, IN (US)

(21) Appl. No.: 14/204,255

(22) Filed: Mar. 11, 2014

Related U.S. Application Data
(60) Provisional application No. 61/792,928, filed on Mar. 15, 2013.

(51) Int. Cl. F02D 41/38; F02M 63/02

(52) U.S. Cl. CPC F02D 41/3863; F02M 63/0275
USPC 123/456; 29/428

(57) ABSTRACT

A fuel rail assembly configured for connection to an internal combustion engine includes a first fuel rail, a second fuel rail, and a crossover hose. The first fuel rail includes an inlet having a first flow restrictor and configured to be coupled to a high-pressure pump. The first fuel rail further includes a second flow restrictor disposed in an interior portion that divides the interior into a first rail volume and a remainder volume. The crossover hose includes a third flow restrictor near the end that is connected to the second fuel rail. A first pulsation control volume is defined between the pump and the inlet. A second pulsation control volume is defined to include the remainder volume and the volume in the crossover hose (i.e., between the first and second flow restrictors). The pulsation control volumes reduce pressure fluctuations produced by the high-pressure pump.

### CROSS-REFERENCE TO RELATED APPLICATIONS

This application claims the benefit of U.S. provisional application No. 61/792,928 filed 15 Mar. 2013, which is hereby incorporated by reference as though fully set forth herein.

### BACKGROUND

a. Technical Field

The instant disclosure relates to a fuel rail assembly.

b. Background Art

This background description is set forth below for the purpose of providing context only. Therefore, any aspects of this background description, to the extent that it does not otherwise qualify as prior art, is neither expressly nor impliedly admitted as prior art against the instant disclosure.

It is known to provide a fuel delivery system for use with an internal combustion engine. Such a system may include one or more fluid conduits that allow for the delivery of pressurized fuel to multiple fuel injectors. The fluid conduit (i.e., a fuel rail) may include an inlet that is connected to an outlet of a fuel source, for example, in some systems, a high-pressure fuel pump. The fluid conduit also typically includes a plurality of outlets that are configured for mating with a corresponding fuel injector. An ongoing challenge involves controlling and/or reducing the amount of pressure variation within the fuel rail itself. Such pressure variation can have an adverse impact on the performance of the engine to which the fuel delivery system is connected.

For example, pressure variation (e.g., pressure waves) may cause inaccurate metering of fuel by the fuel injectors associated with the fuel rail. This degrades the performance of the engine to which the fuel injectors supply fuel because the desired amount of metered fuel may vary with the amount of pressure within the fuel rail. In addition, the pressure waves may cause undesirable noise in the fuel rail. There are different causes of such pressure variation.

One cause of pressure fluctuation applies to fuel delivery systems that employ a high-pressure fuel pump directly connected to the fuel rail(s). It is typical to drive such pumps directly (or indirectly) off of a camshaft and typically has 3 or 4 lobes. Because of this low number of lobes and a high volume per pumping event, the pressure swings of the pump output can be quite high. For example, the pressure levels at the output of such a high-pressure pump can be as low as substantially zero pressure on the low end to as high as 20-21 MPa (e.g., ˜2900 psi) on the high end. Such pressure variations have been challenging to accommodate in conventional fuel delivery systems.

One approach taken to address the above-described problem involves enlarging the size of fuel rails (i.e., increasing the volume of each rail). While effective, this approach (i) increases the material cost of the fuel rail assembly (i.e., increases the amount of materials needed for the rails), and (ii) increases the physical size of the overall fuel rail assembly (i.e., increases the footprint of the package). Some applications cannot accommodate the larger-size package, nor tolerate the lower performance of conventional configurations that can be provided in a smaller-sized package.

The foregoing discussion is intended only to illustrate the present field and should not be taken as a disavowal of claim scope.

### BRIEF SUMMARY

One advantage of embodiments consistent with the present teachings involves improved performance (i.e., reduced pressure fluctuations) as compared to conventional configurations with the same or similar sized fuel rails. Another advantage involves a reduced material cost as compared to conventional, similarly performing but larger-sized fuel rails. A still further advantage involves the ability to meet predetermined performance requirements in a reduced-size package, where conventional approaches, based on enlarged fuel rail configurations, cannot be used. Embodiments consistent with the teachings of the instant disclosure decouple the rail volumes—which feed the injectors—from the pressure swings of the pump, by providing multiple flow restrictors that in turn define multiple pulsation control volumes, as more fully described herein.

In an embodiment, a fuel rail assembly, configured for connection to an internal combustion engine, includes a first fuel rail, a second fuel rail, and a crossover hose. The first fuel rail includes a first interior and an inlet configured to be coupled to a high-pressure fuel pump using a supply hose. A first flow restrictor is located between the pump and the first interior of the first fuel rail. The first fuel rail further includes a second flow restrictor disposed in the first interior (i.e., internal) to divide the first interior into a first rail volume (which feed the injectors) and a remainder volume. The first fuel rail also includes a first crossover port, which is coupled to the crossover hose. The second fuel rail includes a second interior with a second rail volume. The second fuel rail has a second crossover port, which is coupled to the crossover hose. The crossover hose is configured to communicate fuel between the first and second fuel rails. A third flow restrictor is located near to the second crossover port of the second fuel rail (e.g., in an embodiment, it is disposed in the crossover hose).

In an embodiment, a first pulsation control volume is defined between the high-pressure pump and the first flow restrictor (e.g., which may be formed in the inlet, in an embodiment). A second pulsation control volume is also defined, and which includes the remainder volume of the first rail, in addition to the volume of the crossover hose (i.e., the total volume between the second, internal flow restrictor and the third flow restrictor). The first and second pulsation control volumes serve to reduce the pressure fluctuations in the first rail volume and the second rail volume, by decoupling the rail volumes from the pump. In this regard, the fuel rail assembly provides two flow restrictors between the high-pressure pump and each of the first and second rail volumes. In addition, the fuel rail assembly provides two flow restrictors between the first and second fuel rail volumes, thereby decoupling pressure variations induced by injector activity occurring in one rail from affecting the other rail. In addition, the second pulsation control volume in enlarged (and thus more effective) by the incremental volume contributed by the remainder volume of the first fuel rail.

In another aspect, a method of making a fuel rail is described.

The foregoing and other aspects, features, details, utilities, and advantages of the present disclosure will be apparent from reading the following description and claims, and from reviewing the accompanying drawings.

### BRIEF DESCRIPTION OF THE DRAWINGS

FIG. 1 is an isometric view of a fuel delivery system including a fuel rail assembly in accordance with an embodiment.

FIG. 2 is a cross-sectional view of a fluid conduit taken substantially along lines 2-2 in FIG. 1.

FIG. 3 is a schematic view of the fuel rail assembly of FIG. 1, showing, in an embodiment, a plurality of flow restrictors.

FIG. 4A is a cross-sectional view of a portion of one of the fuel rails of FIG. 1, showing, in a first embodiment, an internal flow restrictor.

FIGS. 4B-4C are vertical and horizontal cross-sections of inlet of FIG. 1, showing the first flow restrictor, in an embodiment.

FIG. 5 is a cross-sectional view of a portion of one of the fuel rails of FIG. 1, showing, in a second embodiment, an internal flow restrictor.

FIG. 6 is a flowchart diagram showing, in an embodiment, a method of manufacturing a fuel rail.

FIG. 7-8 are cross-sectional views of a portion of one of the first fuel rail of FIG. 1, in a further embodiment.

FIGS. 9-10 are cross-sectional views of a still further, single-rail embodiment.

### DETAILED DESCRIPTION

Referring now to Figures wherein like reference numerals identify identical or similar components in the various views, FIG. 1 is an isometric view of a fuel delivery system 10 in accordance with an embodiment of the instant disclosure. The fluid delivery system and the components and methods of assembling the same will be described, which may have application with respect to a spark-ignited, fuel-injected internal combustion engine; however, other applications are contemplated, as will be recognized by one of ordinary skill in the art.

The fuel delivery system 10 includes a high-pressure fuel pump 12, a fuel rail assembly 14, and a supply hose or conduit 16 fluidly coupling the pump to the fuel rail assembly 14. The fuel delivery system 10 may be configured for use with a multiple-cylinder internal combustion engine, for example, a six-cylinder engine in the illustrative embodiment. The high-pressure fuel pump 12 is configured with an inlet (shown—but unconnected) for connection to a source of fuel, for example, a low-pressure fuel pump coupled to a fuel tank. As described in the Background, the high-pressure pump 12 may be driven off of an engine camshaft, resulting in large variations in pump output pressure. The high-pressure fuel pump 12 may comprise conventional components known in the art. The outlet of the high-pressure fuel pump 12 is coupled through the supply hose 16 to the fuel rail assembly 14, and may be attached at each end using conventional fluid attachment means (e.g., including nuts 18, 20).

The fuel rail assembly 14 is configured for connection to a plurality of fuel injectors (shown) used in an internal combustion engine (not shown). The fuel rail assembly 14 includes a first fuel rail 22, a second fuel rail 24, and a crossover hose or conduit 26 configured to provide fuel communication between the first and second fuel rails 22, 24.

The first fuel rail 22 includes a fuel inlet 28 that is configured to be coupled to the outlet of the high-pressure pump 12 via the supply hose 16, and a first plurality of output ports 30, including fuel injector receptor cups 32 configured to receive corresponding fuel injectors 34. As also shown, the injectors 34 may be of the electrically-controlled type, and therefore each may include a respective electrical connector 36 configured for connection to an electronic engine controller or the like (not shown). In addition, the first fuel rail 22 may include a plurality of mounts or brackets 38, which can be used in combination with corresponding fasteners 40 or the like to secure the fuel rail assembly 14 within an engine compartment.

The second fuel rail 24 also includes the above-described output ports 30, fuel injector cups 32 for the fuel injectors 34 (and connectors 36), mounting brackets 38, and fasteners 40, and thus a duplicate description will not be set forth again. Only one of port 30, cup 32, injector 34, connector 36, mounting 38 and fastener 40 has been labeled in FIG. 1, for clarity. Each fuel rail 22, 24 also includes a respective end cap 42 on an end that is distal from the inlet 28, configured to fluidly seal that end of the fuel rail, as well as a respective crossover connector 91 (FIG. 4) located on the opposite end, near the inlet-end of the fuel rail 22. The crossover hose 26 may be coupled to the crossover connectors of each fuel rail 22, 24 using conventional means (e.g., nuts). The crossover hose 26 is configured to allow the communication of fuel between the first and second fuel rails.

FIG. 2 is a cross-sectional view of the first fuel rail 22 taken substantially along lines 2-2 in FIG. 1. Each fuel rail 22, 24 comprises a respective fluid conduit 46 extending along a respective longitudinal axis A₁, A₂. For clarity, references to the fluid conduit 46 is intended to refer to the main, tubular component of each fuel rail 22, 24, which include further components as described herein. In an embodiment, each fluid conduit 46 may have a generally circular cross-sectional shape. Each fluid conduit 46 includes a respective interior 48 that can function as a fuel passageway and that fluidly couples the inlet 28 of the fuel rail assembly 14 to the outlets 30, and the crossover hose 26.

Each of the fuel rails 22, 24 and components thereof may be formed of numerous types of materials, such as, for exemplary purposes only, aluminum, various grades of stainless steel, low carbon steel, other metals, and/or various types of plastics. In an embodiment, the fuel rails may be formed of a metal or other materials that can be brazed, and thus can withstand furnace brazing temperatures on the order of 2050° F. (1121° C.)). The fuel rails 22, 24 may further have different thicknesses in various portions. Additionally, although the fuel rails 22, 24 may each have a generally circular cross-sectional shape in the illustrated embodiment, it should be understood that each may alternatively have any number of different cross-sectional shapes, and may be a one-piece fuel rail or have a number of constituent pieces.

FIG. 3 is a schematic diagram 50 corresponding to the fuel delivery system 10 of FIG. 1. As described in the Background, a problem encountered with the use of a camshaft driven high-pressure pump involves the large pressure fluctuations that can propagate to the fuel rails, and the resultant adverse effects on fuel delivery performance. In an aspect of the instant disclosure, a plurality of flow restrictors 52, 54, and 56 are used, as described below, to define pulsation control volumes to pressure fluctuations in the rail volumes, by decoupling the rail volumes from the pressure swings of the pump.

The first flow restrictor 52 is disposed between the outlet of the high-pressure pump 12 and the interior of the first fuel rail 22, which defines a first pulsation control volume 58. In an embodiment, the first flow restrictor 52 may be integral with the inlet 28, as best shown in FIG. 4. In addition, the second flow restrictor 54 may be disposed in the first interior of the first fuel rail 22, to divide the interior 62 into a first rail volume 66 (which feeds the injectors) and a remainder volume 68 (which becomes part of the second pulsation control volume 60—described below). A number of embodiments of the second flow restrictor 54 will be described in connection with FIGS. 4-5. Finally, a third flow restrictor 56 is located near the crossover-port end of the second fuel rail 24, and which may be located either (i) in the end of the crossover hose 26 (as illustrated) or (ii) in the crossover connector of the second fuel rail 24.

The above-described placement of flow restrictors forms a second pulsation control volume 60 between the second flow restrictor 54 and the third flow restrictor 56. In this regard, a part of the first fuel rail 22, namely, the remainder volume 68, is added to the volume of the crossover hose 26 in order to form an enlarged second pulsation control volume 60. In light of the placement of the flow restrictors, the fuel rail assembly 14 includes (i) a first rail volume 66 in the first fuel rail 22 that is in fluid communication with a first plurality of injector outlets, and (ii) a second rail volume 64 in the second fuel rail 24 that is in fluid communication with a second plurality of fuel injector outlets.

The first and second pulsation control volumes 58, 60 are configured to reduce the magnitude of the pressure fluctuations experienced in either of the first or second rail volumes 66, 64. In other words, the first and second pulsation control volumes 58, 60 act as damping volumes with respect to the rail volumes 66, 64. The configuration of the fuel rail assembly 14 places two flow restrictors between the first rail volume 66 and the high-pressure pump 12, and the second rail volume 64 and the high-pressure pump 12. This de-couples the rail volumes 66, 64 from the adverse effects of the pump output fluctuations. In addition, the fuel rail assembly 14 places two flow restrictors between the first rail volume 66 and the second rail volume 66, which serve to reduce pressure differentials between the rail volumes 66, 64.

The relative sizing of the pulsation control volumes, relative to the rail volumes, can provide further improvements in performance. In an embodiment, a first ratio between the second pulsation control volume 60 to the first pulsation control volume may be between about 2 and 5, and may be between about 4 and 5. In an embodiment, a second ratio between the first rail volume 66 and the second pulsation control volume 60 may be between about 3 and 6, and may be between about 3 and 5. Likewise, a third ratio between the second rail volume 64 and the second pulsation control volume 60 may be between about 3 and 6, and may be between about 3 and 5. It should be understood that these ratio ranges are exemplary only and not limiting in nature.

Each of the flow restrictors 52, 54, and 56 may comprise conventional components known in the art, for example only, a small diameter orifice of conventional construction. In an embodiment, each of the flow restrictors 52, 54, and 56 may comprise a small orifice having a diameter of between about 0.70 mm and 2.00 mm, and may be about 1.10 and 1.16 mm in one embodiment.

FIG. 4A is a cross-sectional view of the inlet-end of the first fuel rail 22. In the illustrative embodiment, the inlet 28 may be formed with an integral first flow restrictor 52, which may be a necked-down (restricted) passage 52. The inlet 28 is positioned along the fuel rail 22 so that it is coupled to the remainder volume 68.

FIGS. 4B-4C are simplified, vertical and horizontal cross-sections of the inlet 28 of FIG. 1, showing the first flow restrictor 52 in greater detail.

FIGS. 7-8 are cross-sectional views of the first fuel rail of FIG. 1, in an embodiment. As shown, inlet 28 may comprise a plurality of segments, designated 28a, 28b, and 28c. The first flow restrictor 52 is also shown. In addition, another embodiment of the crossover connector is shown, designated crossover connector 91a. In addition to the connector portion 92, and shank portion 94, the crossover connector 91a includes an enlarged-diameter intermediate portion 114 that defines a shoulder 116. As shown, shoulder 116 provides a mechanical stop by engaging the end edge of fluid conduit 46a, to limit the insertion travel of the crossover connector 91a. The insertion tool 98 (shown in FIG. 7, not shown in FIG. 8) can be used to insert the second flow restrictor, described in greater detail below. In addition, in another embodiment of the fluid conduit 46, designated fluid conduit 46a, the enlarged, inside diameter portion exists only at the extreme end, to accommodate the crossover connector 91a, but necks down before reaching the inlet 28/first flow restrictor 52.

With continued reference to FIG. 4A, in an embodiment, the second flow restrictor 54, which divides the interior volume of the conduit 46, may take the form of a cup 70. The cup 70 has a sidewall 72 extending from a base 74. A free edge 76 of the cup 70 defines a top opening 78. The cup 70 is disposed in the interior of the conduit 46 so that the top opening 78 faces toward the first rail volume 66, while the base 74 acts as a dividing wall between rail volume 66 and the remainder volume 68. The cup further includes a hole 80, whose purpose will be described below.

In one embodiment, the hole 80 itself is sized, for example as described above, to act as a flow restrictor. However, in another embodiment, the hole 80 is enlarged sufficiently to accept an insert 82, which includes an orifice 84 that is sized to operate as a flow restrictor, again, for example only, as described above. In the latter embodiment, the larger hole 80 has the advantage of allowing for adequate venting during manufacturing, for example, during a brazing process, to allow heated gases to more easily exit from the fuel rail. In addition, insertion of the insert 82 (with orifice 84) after manufacturing (i.e., after brazing) allows for improved brazing and further permits keeping the orifice clear and clean from brazing materials (e.g., copper braze flash) that could otherwise clog the orifice.

With continued reference to FIG. 4A, in an embodiment, the fuel rail 22, in particular the fluid conduit 46, is adapted to receive the cup 70 at a specified desired longitudinal position from the end opening. This is accomplished by providing a mechanical stop. In this regard, the outer wall of the fluid conduit 46 has a first inside diameter portion 86, which is near the inlet 28, and the end opening of the fluid conduit 46 that receives the crossover connector 91. The outer wall of the fluid conduit 46 also has a second inside diameter portion 88, which is smaller than the first inside diameter portion 86, and which is relatively distal from the inlet 28. The diameter of the cup 70 is configured in size such that it can be introduced through the end opening (before the crossover connector is inserted), with insertion continuing until the free edge 76 engages a transition 90 between the first and second inside diameter portions 86, 88. In other words, the transition 90 acts as a mechanical stop relative to the cup 70.

FIG. 4A also shows the crossover connector 91, which includes a connector portion 92 and a shank portion 94 configured in size and shape to fit into the first inside diameter portion 86. The crossover connector 91 also includes a crossover port 96 extending axially therethrough that allows fuel to be communicated in and out of the remainder volume. The crossover connector 91 may comprise conventional construction and materials. FIG. 4A also shows an insertion tool 98, to be used in a method of manufacturing a fuel rail, to be described below in connection with FIG. 6.

FIG. 5 is a cross-sectional view of another embodiment of the second flow restrictor 54. In this embodiment, rather than the cup 70, a divider wall 100 with an through orifice 102 (i.e., flow restrictor 54), is formed in the interior of the fluid conduit 46, at desired longitudinal position. The divider wall 100 is oriented generally transverse to the longitudinal axis A₁ and performs generally the same function as the base 74 of cup 70. The orifice 102 can take the form of a hole (as shown), or can take the form of an insert, like the insert 82 in FIG. 4A.

The third flow restrictor 56 may be disposed in the crossover hose 26, or alternatively as part of the crossover connector of the second fuel rail 24. In an embodiment, the third flow restrictor 56 may be an insert that reduces the diameter of the crossover hose 26, for example, as seen by reference to U.S. application Ser. No. 10/721,943, filed 25 Nov. 2003 (the '943 application), now U.S. Pat. No. 7,021,290, which is hereby incorporated by reference as though fully set forth herein.

FIG. 6 is a flowchart diagram showing a method of manufacturing a fuel rail, for example, the first fuel rail 22, for use in a fuel rail assembly 14, which in turn can be used in a fuel delivery system 10. The method begins in step 104.

In step 104, the method involves providing a fluid conduit (e.g., item 46) that includes an inlet, one or more outlets (e.g., for coupling to an injector cup), and an end cap or the like to close one end opening of fluid conduit 46, while retaining the other, opposing end opening clear and open. Generally, the fluid conduit 46 may include the features already described above. The method then proceeds to step 106.

In step 106, the method further involves introducing a cup—top opening first—through the uncapped end opening of the fluid conduit 46, with continued insertion, in an embodiment, until the cup engages the transition region 90 (i.e., mechanical stop). The cup may be the cup described above, e.g., cup 70, which includes a through-hole 80 in its base 74. The method proceeds to step 108.

In step 108, the method further involves introducing a crossover connector—shank end first—into the uncapped end opening of the fluid conduit 46. The crossover connector may be the connector 91 described herein. The foregoing steps form a sub-assembly the fuel rail 22. The method proceeds to step 110.

In step 110, the method further involves performing a brazing operation on the sub-assembly that was formed in step 108. In an embodiment, this brazing operation may involve a furnace brazing process. To perform this step, brazing material may be placed at the locations where components are to be affixed together, e.g., around the outside surface of the cup 70, where the endcap 46 engages the distal end of the fluid conduit 46, where the outside surface of the shank 94 of the crossover connector 91 contacts the first inside diameter portion 86, etc.

The brazing material may be characterized as having a melting point such that it will change from a solid to a liquid when exposed to the level of heat being applied during the brazing operation (e.g., on the order of 2050° F. (1121° C.)), and which will then return to a solid once cooled. Examples of materials that can be used include without limitation, for exemplary purposes only, pre-formed copper pieces, copper paste, various blends of copper and nickel and various blends of silver and nickel, all of which have melting points on the order of approximately 1200-2050° F. (650-1121° C.). As the heating and cooling steps of the brazing operation are performed, the brazing material melts and is pulled into the joint(s)/contact surfaces described above. Once sufficiently cooled, the brazing material returns to a solid state, to thereby fix together the components of the sub-assembly. The method then proceeds to step 112.

In step 112, the method further involves securing an insert, e.g., insert 82, having an orifice, e.g., orifice 84, in the cup hole 80. In an embodiment, this step is performed using the insertion tool 98. In particular, the insert 82 is first loaded onto the end of the insertion tool 98, and is introduced into the interior of the fluid conduit 46 through the crossover port 96, moving in a generally longitudinal direction. When the insert 82 has been introduced far enough to reach the hole 80, the insert 82 can then be secured in the hole 80. In one embodiment, the insert can be threaded into a like-threaded hole 80. In another embodiment, the insert 82 can be press-fit into hole 80. In a still further embodiment, the insert 82 can be spin welded into the hole 80. Other conventional affixation methods may be used to secure the insert 82 in the hole 80.

It should be understood that variations are possible, as seen by reference to FIGS. 9-10.

FIGS. 9-10 are cross-sectional views of a single-rail fuel rail assembly, in a still further embodiment. The teachings of the instant disclosure can be applied to a single fuel rail arrangement, which also benefit from the first and second pulsation control volumes.

In one single-rail embodiment (not shown) the inlet 28 includes the first flow restrictor and the first fuel rail 22 includes the second flow restrictor 54, but does not include the crossover connector 91, the crossover hose 26, or the second fuel rail 24. The end opening of the fluid conduit 46 previously occupied by the crossover connector 91 in the above-described embodiment may be replaced by a further end-cap or the like to close the end opening. The first pulsation control volume 58 remains as described in connection with the fuel rail assembly 14. A second pulsation control volume 60 is modified, and now corresponds to the remainder volume 68 described above (i.e., without the additional volume of the crossover hose 26).

In a second single-rail embodiment, shown in FIGS. 9-10, the inlet 28 is eliminated from the modified fluid conduit 46b, and the first flow restrictor, now a torus-shaped ring 118, is positioned in a correspondingly-sized hole 120 of an end connector 91b. The end connector 91b is configured to be fluidly coupled to the high-pressure pump 12 (FIG. 1). The first flow restrictor 118 includes a reduced-diameter orifice 122 therethrough, which may be sized as described herein. FIG. 9 shows cup 70 having hole 80 without insert 82, while FIG. 10, in an embodiment, shows insert 82 secured in the hole 80. The single fuel rail embodiment maintains two pulsation control volumes, the first being defined between the pump 12 and the first flow restrictor 118, and a second pulsation control volume designated 68a in this embodiment (i.e., corresponding to the remainder volume 68 described above in connection with a two-rail embodiment. The first rail volume 66 is also shown. The pulsation control volumes are characterized by the same advantages as described herein. The single fuel rail embodiment may find application to, for example, an 4-cylinder, 14 (inline) type spark-ignition internal combustion engine for an automotive vehicle.

Embodiments consistent with the present teachings have the advantage of improved performance (i.e., reduced pressure fluctuations) as compared to conventional configurations with the same or similar sized fuel rails. Another advantage involves a reduced material cost as compared to conventional, similarly performing but larger-sized fuel rails. A still further advantage involves the ability to meet predetermined performance requirements in a reduced-size package, where conventional approaches, based on enlarged fuel rail configurations, cannot be used. Embodiments consistent with the teachings of the instant disclosure decouple the rail volumes—which feed the injectors—from the pressure swings of the pump, by providing multiple flow restrictors that in turn define multiple pulsation control volumes.

It should be understood that the terms “top”, “bottom”, “up”, “down”, and the like are for convenience of description only and are not intended to be limiting in nature.

While one or more particular embodiments have been shown and described, it will be understood by those of skill in the art that various changes and modifications can be made without departing from the spirit and scope of the present teachings.

What is claimed is:

1. A fuel rail assembly configured for connection to an internal combustion engine, comprising:
a first fuel rail having a first interior and an inlet configured to be coupled to a high-pressure fuel pump using a supply hose wherein a first flow restrictor is disposed between the pump and the first interior, said first fuel rail further having a second flow restrictor disposed in the first interior to form a first rail volume and a remainder volume, said first fuel rail further having a first crossover port;
a second fuel rail having a second interior with a second rail volume, said second fuel rail having a second crossover port;
a crossover hose coupled to said first and second crossover ports and configured to allow communication of fuel between said first and second fuel rails; and
a third flow restrictor proximate said second crossover port and disposed in one of said crossover hose and said second fuel rail.

2. The fuel rail assembly of claim 1 wherein said inlet of said first fuel rail and said first crossover port are coupled to said remainder volume.

3. The fuel rail assembly of claim 1 wherein said first fuel rail includes a first plurality of injector outlets coupled to said first rail volume, and said second fuel rail includes a second plurality of injector outlets coupled to said second rail volume.

4. The fuel rail assembly of claim 1 wherein a first control volume is defined between the pump and said first flow restrictor, and a second control volume is defined between said second flow restrictor and said third flow restrictor; and
wherein a first ratio between said second control volume and said first control volume is between about 2-5, and a second ratio between said first rail volume and said second control volume is between about 3-6, and a third ratio between said second rail volume and said second control volume is between about 3-6.

5. The fuel rail assembly of claim 4 wherein said second ratio is between about 3-5 and said third ratio is between about 3-5.

6. The fuel rail assembly of claim 1 wherein said first flow restrictor is formed in said inlet.

7. The fuel rail assembly of claim 1 wherein said first fuel rail has a longitudinal axis associated therewith and includes an outer wall, said first fuel rail further includes a divider wall in said first interior disposed generally transverse with respect to said axis, said divider wall including said second flow restrictor.

8. The fuel rail assembly of claim 1 wherein said first fuel rail has a longitudinal axis associated therewith and includes an outer wall, further comprising a cup having a sidewall extending from a base and wherein a free edge of said sidewall defines a top opening, said cup being disposed in said first interior so that said top opening is facing said first rail volume, said base including a hole therethrough defining said second flow restrictor.

9. The fuel rail assembly of claim 1 wherein said first fuel rail has a longitudinal axis associated therewith and includes an outer wall, further comprising a cup having a sidewall extending from a base and wherein a free edge of said sidewall defines a top opening, said cup being disposed in said first interior so that said top opening is facing said first rail volume, said base including a hole therethrough, further comprising an insert having an outer surface configured in size and shape to be disposed in said hole, said insert further including an orifice defined therethrough defining said second flow restrictor.

10. The fuel rail assembly of claim 9 wherein said outer wall has a first inside diameter portion that is proximate said inlet, and a second inside diameter portion, smaller than said first inside diameter portion, that is distal of said inlet, said free edge of said cup abutting a transition between said first diameter portion and said second diameter portion.

11. The fuel rail assembly of claim 1 wherein said third flow restrictor is disposed in said crossover hose.

12. A method of making a fuel rail, comprising:
providing a fluid conduit that extends along a longitudinal axis and has an inlet, an end opening, at least one outlet, and a fluid flow passageway configured to allow fluid to be communicated between said inlet and said at least one outlet;
inserting a cup through said end opening into said fluid conduit wherein said cup has a sidewall extending from a base and wherein a free edge of said sidewall defines a top opening, said cup base including a hole therethrough;
placing a crossover connector in said end opening;
performing a brazing process on said fluid conduit; and
securing an insert in said cup hole wherein said insert includes an orifice configured to restrict flow therethrough.

13. The method of claim 12 wherein said providing a fluid conduit includes:
providing a mechanical stop formed on an inside surface of said conduit; and
wherein said inserting a cup includes inserting the cup into said conduit until said free edge engages said mechanical stop.

14. The method of claim 12 wherein said performing a brazing process includes performing a furnace brazing process.

15. The method of claim 12 further including inserting the insert through a port in said crossover connector along said axis into said passageway until reaching said hole in said cup.

16. The method of claim 12 wherein said cup hold includes inside threads, and said insert includes outside threads, said securing includes threading said insert into said hole.

17. The method of claim 12 wherein said securing including spin welding the inert into said cup hole.

18. A fuel rail assembly configured for connection to an internal combustion engine, comprising:
a first fuel rail having a first interior and an inlet configured to be coupled to a high-pressure fuel pump using a supply hose, and wherein said inlet includes a first flow restrictor, said first fuel rail further having a second flow restrictor disposed in the first interior to divide said interior into a first rail volume and a remainder volume wherein said first inlet is coupled to said remainder volume;
said first fuel rail including a first plurality of outlets coupled to said first rail volume configured for connection to a corresponding plurality of fuel injectors; and
wherein a first control volume is defined between the pump and said first flow restrictor, and a second control volume includes said remainder volume.

19. The fuel rail assembly of claim 18 wherein said first fuel rail includes a first crossover port coupled to said remainder volume, said assembly further comprising:
a second fuel rail having a second interior with a second rail volume, said second fuel rail including a second plurality of outlets configured for connection to a corresponding plurality of fuel injectors, said second fuel rail having a second crossover port;
a crossover conduit coupled to said first and second crossover ports and configured to communicate fuel between said first and second fuel rails, said crossover conduit including a third flow restrictor proximate said second crossover port;
said second control volume being defined between said second flow restrictor and said third flow restrictor; and wherein a first ratio between said second control volume and said first control volume is between about 2-5, and a second ratio between said first rail volume and said second control volume is between about 3-6, and a third ratio between said second rail volume and said second control volume is between about 3-6.
